(19) United States
(12) Patent Application Publication
(10) Pub. No.: US 2025/0378585 A1
(43) Pub. Date: Dec. 11, 2025

(54) CONTENT-BASED IMAGE COMPRESSION VIA PROBABILISTIC REGION OF INTEREST SEGMENTATION

(71) Applicant: QUALCOMM Incorporated, San Diego, CA (US)

(72) Inventors: Madhumitha Sakthi, San Diego, CA (US); Varun Ravi Kumar, San Diego, CA (US); Louis Joseph Kerofsky, San Diego, CA (US); Senthil Kumar Yogamani, Headford (IE)

(21) Appl. No.: 18/740,037

(22) Filed: Jun. 11, 2024

(51) Int. Cl. G06T 9/00; G06T 7/11; G06V 10/25; G06V 10/764

(52) U.S. Cl. CPC G06T 9/00; G06T 7/11; G06V 10/25; G06V 10/764

(57) ABSTRACT

A computing system may segment an image frame into three or more probabilistic regions, wherein each of the three or more probabilistic regions is associated with a corresponding confidence level of being within a region of interest in the image frame out of a plurality of confidence levels of being within the region of interest. A computing system may determine, for each of the three or more probabilistic regions, a corresponding compression ratio based on the corresponding confidence level of being within the region of interest. A computing system may compress each of the three or more probabilistic regions according to the corresponding compression ratio.

### TECHNICAL FIELD This disclosure relates to image compression.

### BACKGROUND

Autonomous vehicles and semi-autonomous vehicles may use artificial intelligence (AI) and machine learning (ML) (e.g., neural networks) for performing various operations for operating, piloting, and navigating the vehicles. For example, neural networks may be used for object detection, lane and road boundary detection, safety analysis, drivable free-space analysis, control generation during vehicle maneuvers, and/or other operations. Neural network-powered autonomous and semi-autonomous vehicles should be able to respond properly to an incredibly diverse set of situations, including interactions with emergency vehicles, pedestrians, animals, and a virtually infinite number of other obstacles.

For autonomous vehicles to achieve autonomous driving levels 3-5 (e.g., conditional automation (Level 3), high automation (Level 4), and full automation (Level 5)) the autonomous vehicles should be capable of operating safely in all environments, and without the requirement for human intervention when potentially unsafe situations present themselves. An Advanced Driver Assistance System (ADAS) uses sensors and software to help vehicles avoid hazardous situations to ensure safety and reliability.

### SUMMARY

In general, this disclosure describes techniques for compressing images used to train neural networks used for automotive perception in ways that better preserve certain details of objects of interest in the compressed images. Due to the use of large datasets of high resolution images to train robust automotive perception models, systems for training automotive perception models may compress such images to reduce the amount of storage space that may be required to store such datasets. Techniques that improve the preservation of certain details of objects of interest in the compressed images may enable automotive perception models to be trained to more accurately recognize objects.

A computing system may train neural networks used for autonomous and semi-autonomous vehicles to recognize objects (e.g., vehicles, obstacles, pedestrians, cyclists, lane boundaries, road boundaries, etc.) using large-scale datasets of image data and/or sensor data featuring such objects. Such neural networks used for autonomous and semi-autonomous vehicles to recognize objects is referred to herein as an automotive perception model. Data in such datasets are annotated (e.g., labeled) to identify and specify the location and category of objects within the data. For example, pixels of an image in the dataset may each be assigned a label that indicates to which object (e.g., a vehicle, a lane marking, etc.) or background the object belongs. Such annotation of the data may enable the computing system to train the neural networks via supervised learning to recognize and predict the positions and classes of objects.

A computing system that compresses images used for training automotive perception models may determine, for each pixel or block of an image, a corresponding probability of the pixel or block being in a region of interest. A region of interest in the image may be a region (e.g., a plurality of pixels) of the image that contains an object of interest. An object of interest, for automotive perception applications, may include vehicles, obstacles, pedestrians, cyclists, lane boundaries, road boundaries, road signs, stop lights, and the like.

The computing system may segment an image into a plurality of probabilistic regions, where each of the probabilistic regions is associated with a different corresponding confidence level of being within a region of in the image. To segment an image into the plurality of probabilistic regions, the computing system may determine, such as by using semantic segmentation, for each pixel or block of the image, a corresponding probability of the pixel or the block being in the region of interest of the image. The computing system may therefore assign each pixel or block of the image to different probabilistic regions of the image based on the corresponding probabilities of being in the region of interest.

The computing system may apply different levels of compression to the different probabilistic regions associated with different corresponding confidence levels of being within a region of interest in the image. The computing system may compress each of the probabilistic regions according to a compression ratio that inversely relates to the corresponding confidence level of the probabilistic region being within the region of interest of the image. That is, the computing system may heavily compress a probabilistic region having a relatively low corresponding confidence level of being within a region of interest in the image, and may more lightly compress another probabilistic region having a relatively high corresponding confidence level of being within a region of interest in the image.

In some aspects, the techniques described herein relate to a method including: segmenting an image frame into three or more probabilistic regions, wherein each of the three or more probabilistic regions is associated with a corresponding confidence level of being within a region of interest in the image frame out of a plurality of confidence levels of being within the region of interest; determining, for each of the three or more probabilistic regions, a corresponding compression ratio based on the corresponding confidence level of being within the region of interest; and compressing each of the three or more probabilistic regions according to the corresponding compression ratio.

In some aspects, the techniques described herein relate to a computing system including: a memory; and processing circuitry implemented in circuitry, coupled to the memory, and configured to: segment an image frame into three or more probabilistic regions, wherein each of the three or more probabilistic regions is associated with a corresponding confidence level of being within a region of interest in the image frame out of a plurality of confidence levels of being within the region of interest; determine, for each of the three or more probabilistic regions, a corresponding compression ratio based on the corresponding confidence level of being within the region of interest; and compress each of the three or more probabilistic regions according to the corresponding compression ratio.

In some aspects, the techniques described herein relate to a computer-readable storage medium storing instructions thereon that when executed cause processing circuitry to: segment an image frame into three or more probabilistic regions, wherein each of the three or more probabilistic regions is associated with a corresponding confidence level of being within a region of interest in the image frame out of a plurality of confidence levels of being within the region of interest; determine, for each of the three or more probabilistic regions, a corresponding compression ratio based on the corresponding confidence level of being within the region of interest; and compress each of the three or more probabilistic regions according to the corresponding compression ratio.

In some aspects, the techniques described herein relate to an apparatus including: means for segmenting an image frame into three or more probabilistic regions, wherein each of the three or more probabilistic regions is associated with a corresponding confidence level of being within a region of interest in the image frame out of a plurality of confidence levels of being within the region of interest; means for determining, for each of the three or more probabilistic regions, a corresponding compression ratio based on the corresponding confidence level of being within the region of interest; and means for compressing each of the three or more probabilistic regions according to the corresponding compression ratio.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example computing system.

FIG. 2 is a conceptual diagram illustrating probabilistic segmentation of an example image frame, according to the techniques of this disclosure.

FIG. 3 is a flowchart showing an example method for performing content-based image compression of an image frame, according to the techniques of this disclosure.

FIG. 4 is a flowchart showing an example method of operation according to the techniques of this disclosure.

### DETAILED DESCRIPTION

In general, this disclosure describes techniques for compressing images used to train neural networks used for automotive perception in ways that better preserve the details of objects of interest in the compressed images. Instead of classifying regions of an image as either being a region of interest (RoI) or not being a RoI, this disclosure describes techniques for probabilistic classification of regions of an image based on the probability of the region being in the RoI and compressing the different probabilistic regions according to the corresponding probability of being in the RoI.

Training neural networks for object recognition, such as automotive perception, depends heavily on the availability of large, high-quality image datasets. These datasets represent various real-world scenarios to ensure robustness and accuracy. However, storing these datasets may incur significant costs due to the high resolution of the images in the datasets and the large volume of the images that may be required to train automotive perception models.

One approach to mitigating storage requirements for such datasets involves the use of conventional lossy image compression techniques. While these techniques may effectively reduce file sizes, these techniques are predominantly optimized for human viewing of images, and thus often fail to preserve important details that may be needed for accurate training of perception models.

Another approach that is used in training perception models to mitigate storage requirements for such datasets involves performing binary classification of images in the datasets. In binary classification, pixels of an image are classified as either being in a RoI or not being in a RoI. A pixel is classified as being in a RoI if the pixel is contained in an object of interest (e.g., vehicles, obstacles, pedestrians, cyclists, lane boundaries, road boundaries, etc.), or is classified as not being in a RoI if the pixel is not contained in object of interest (e.g., the pixel is classified as the sky, a self-occlusion, etc.). A computing system may compress images in the dataset based on such binary classification of images by more heavily compressing the regions of an image that are not in a RoI compared to the regions of an image that are in a RoI.

However, compressing images based on a binary classification of images may not adequately preserve important details of objects in the images that may be needed for accurate training of perception models. For example, pixels at or near the edges of objects of interest in the image may be classified as not being in a RoI and may therefore be subject to heavier compression than the RoI. This may prevent the resulting compressed images from preserving the details of edges or boundaries of objects of interest in the images, and may adversely affect the training of perception models.

Further, compressing images based on such binary classification of images may also lead to hard boundaries between RoI regions and non-RoI regions in the compressed images, and may therefore cause block artifacts at such boundaries. These artifacts can adversely affect the training of perception models by introducing inaccuracies in the model training process, particularly in edge detection and object recognition tasks, which may be important for automotive perception applications.

In accordance with aspects of this disclosure, a computing system may segment an image into a plurality of probabilistic regions each associated with a different corresponding confidence level of being within a RoI in the image. To segment an image into the plurality of probabilistic regions, the computing system may determine, such as by using semantic segmentation, for each block or pixel of the image, a corresponding probability of the block or pixel being in the RoI of the image, and may assign blocks or pixels of the image to different probabilistic regions of the image based on the corresponding probabilities of being in the RoI.

By segmenting an image into a plurality of probabilistic regions each associated with a different corresponding confidence level of being within a RoI in the image, the computing system may apply different levels of compression to the different probabilistic regions associated with different corresponding confidence levels of being within a RoI in the image. The computing system may compress each of the probabilistic regions according to a compression ratio that inversely relates to the corresponding confidence level of the probabilistic region being within the RoI of the image. That is, the computing system may heavily compress a probabilistic region having a relatively low corresponding confidence level of being within the RoI, and may more lightly compress another probabilistic region having a relatively high corresponding confidence level of being within the RoI.

For example, the computing system may segment an image into a certain RoI region, a probable RoI region, a probable non-RoI region, and a certain non-RoI region. The certain RoI region may be associated with the highest confidence level of being within a RoI out of the probabilistic regions and may include pixels or blocks each having a corresponding probability of being within a RoI that is above a RoI threshold value. The computing system may apply the least amount of compression to the certain RoI region.

The probable RoI region may be associated with the second highest confidence level of being within a RoI out of the probabilistic regions and may include pixels or blocks surrounding the edges and/or boundaries of the certain RoI region each having a corresponding probability of being within a RoI that is below the RoI threshold value. The probable RoI region may include pixels or blocks in which it is likely but uncertain whether pixels of an object of interest is present. While the probable RoI region may be compressed according to a compression ratio that is higher than the compression ratio of the certain RoI region, the compression ratio of the probable RoI region may be lower than the compression ratios of the probable non-RoI region and the certain non-RoI region due to the region being likely to contain pixels of an object of interest, thereby preserving details around object boundaries after compression.

The probable non-RoI region may be associated with the third highest confidence level of being within a RoI out of the probabilistic regions and may include pixels or blocks surrounding the edges of the probable RoI region and are within a threshold distance from the edges of the probable RoI region. The probable non-RoI region may include pixels or blocks that are most likely to contain background or non-objects, but may include pixels of an object of interest. While the probable non-RoI region may be compressed according to a compression ratio that is higher than the compression ratios of the certain RoI region and the probable RoI region, the compression ratio of the probable non-RoI region may be lower than the compression ratio of the certain non-RoI region to preserve details around object boundaries after compression.

The certain non-RoI region may be associated with the fourth highest confidence level of being within a RoI out of the probabilistic regions and may include any pixels or blocks that are further away from the certain RoI region than the pixels or blocks in the probable RoI region. The pixels or blocks of the certain non-RoI region may therefore be pixels or blocks that are predicted with high confidence of being background and/or as not containing pixels of an object of interest. The computing system may therefore compress the certain non-RoI region according to the highest compression ratio out of the probabilistic regions.

By segmenting an image into a plurality of probabilistic regions each associated with a different corresponding confidence level of being within a region of interest in the image, the technique of this disclosure may enable a computing system to compress each of the probabilistic regions according to a compression ratio based on the corresponding confidence level of being within the region of interest. For example, a computing system may compress each of the probabilistic regions according to a compression ratio that inversely correlates with the corresponding confidence level of being within the region of interest. In this way, the techniques of this disclosure may be able to efficiently compress images used to train automotive perception models to reduce the amount of storage space used to store such images while prioritizing preserving the details of objects of interest and the edges of such objects to increase the accuracy of automotive perception models trained using such images.

Further, to avoid compression artifacts that may occur due to compressing adjacent regions of an images according to different compression ratios, the computing system may spatially smooth the compression parameters across boundaries between probabilistic regions. That is, the computing system may gradually increase or decrease the compression ratio across adjacent probabilistic regions. By spatially smoothing the compression parameters across boundaries between probabilistic regions, the techniques of this disclosure may reduce compression artifacts at or near such boundaries in the compressed image, thereby improving the image quality of compressed images used to train automotive perception models.

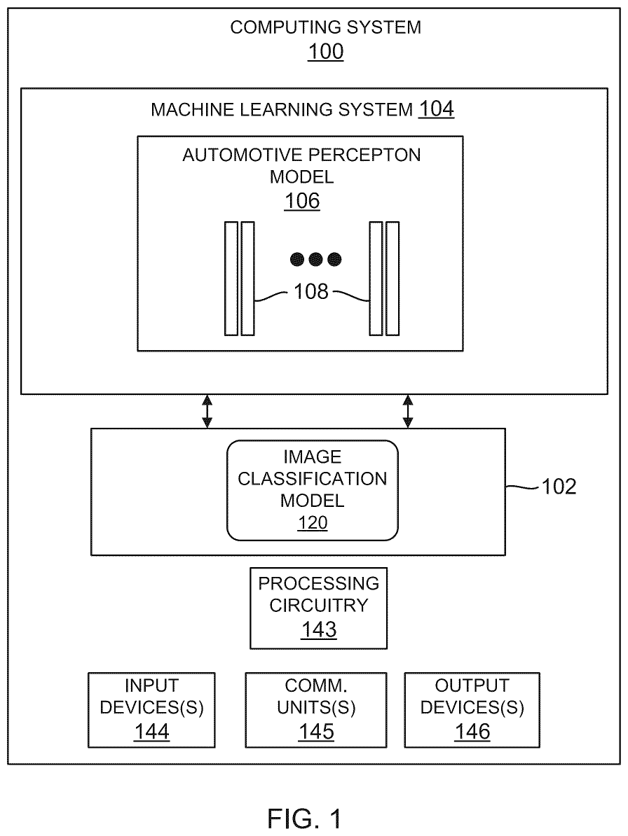

FIG. 1 is a block diagram illustrating an example computing system 100. As shown, computing system 100 comprises processing circuitry 143 and memory 102 for executing a machine learning system 104. In an aspect, machine learning system 104 may execute to train one or more neural networks, such as, such as automotive perception model 106 (also referred to herein as, “machine learning model 106”) comprising layers 108. The machine learning model 106 may comprise any of various types of neural networks, such as, but not limited to, recursive neural networks (RNNs), convolutional neural networks (CNNs), and deep neural networks (DNNs). In the example of FIG. 1, memory 102 may include image classification model 120.

Computing system 100 may also be implemented as any suitable external computing system, such as one or more server computers, workstations, laptops, mainframes, appliances, cloud computing systems, High-Performance Computing (HPC) systems (i.e., supercomputing) and/or other computing systems that may be capable of performing operations and/or functions described in accordance with one or more aspects of the present disclosure. In some examples, computing system 100 may represent a cloud computing system, server farm, and/or server cluster (or portion thereof) that provides services to client devices and other devices or systems. In other examples, computing system 100 may represent or be implemented through one or more virtualized compute instances (e.g., virtual machines, containers, etc.) of a data center, cloud computing system, server farm, and/or server cluster.

The techniques described in this disclosure may be implemented, at least in part, in hardware, software, firmware or any combination thereof. For example, various aspects of the described techniques may be implemented within processing circuitry 143 of computing system 100, which may include one or more of a microprocessor, a controller, a digital signal processor (DSP), an application specific integrated circuit (ASIC), a field-programmable gate array (FPGA), or equivalent discrete or integrated logic circuitry, or other types of processing circuitry. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

In another example, computing system 100 comprises any suitable computing system having one or more computing devices, such as desktop computers, laptop computers, gaming consoles, smart televisions, handheld devices, tablets, mobile telephones, smartphones, etc. In some examples, at least a portion of computing system 100 is distributed across a cloud computing system, a data center, or across a network, such as the Internet, another public or private communications network, for instance, broadband, cellular, Wi-Fi, ZigBee, Bluetooth® (or other personal area network-PAN), Near-Field Communication (NFC), ultrawideband, satellite, enterprise, service provider and/or other types of communication networks, for transmitting data between computing systems, servers, and computing devices.

Memory 102 may comprise one or more storage devices. One or more components of computing system 100 (e.g., processing circuitry 143, memory 102, machine learning model 106, etc.) may be interconnected to enable inter-component communications (physically, communicatively, and/or operatively). In some examples, such connectivity may be provided by a system bus, a network connection, an inter-process communication data structure, local area network, wide area network, or any other method for communicating data. Processing circuitry 143 of computing system 100 may implement functionality and/or execute instructions associated with computing system 100. Examples of processing circuitry 143 include microprocessors, application processors, display controllers, auxiliary processors, one or more sensor hubs, and any other hardware configured to function as a processor, a processing unit, or a processing device. Computing system 100 may use processing circuitry 143 to perform operations in accordance with one or more aspects of the present disclosure using software, hardware, firmware, or a mixture of hardware, software, and firmware residing in and/or executing at computing system 100. The one or more storage devices of memory 102 may be distributed among multiple devices.

Memory 102 may store information for processing during operation of computing system 100. In some examples, memory 102 comprises temporary memories, meaning that a primary purpose of the one or more storage devices of memory 102 is not long-term storage. Memory 102 may be configured for short-term storage of information as volatile memory and therefore not retain stored contents if deactivated. Examples of volatile memories include random access memories (RAM), dynamic random-access memories (DRAM), static random-access memories (SRAM), and other forms of volatile memories known in the art. Memory 102, in some examples, may also include one or more computer-readable storage media. Memory 102 may be configured to store larger amounts of information than volatile memory. Memory 102 may further be configured for long-term storage of information as non-volatile memory space and retain information after activate/off cycles. Examples of non-volatile memories include magnetic hard disks, optical discs, Flash memories, or forms of electrically programmable memories (EPROM) or electrically erasable and programmable (EEPROM) memories. Memory 102 may store program instructions and/or data associated with one or more of the modules described in accordance with one or more aspects of this disclosure.

Processing circuitry 143 and memory 102 may provide an operating environment or platform for one or more modules or units (e.g., machine learning model 106), which may be implemented as software, but may in some examples include any combination of hardware, firmware, and software. Processing circuitry 143 may execute instructions and the one or more storage devices, e.g., memory 102, may store instructions and/or data of one or more modules. The combination of processing circuitry 143 and memory 102 may retrieve, store, and/or execute the instructions and/or data of one or more applications, modules, or software. The processing circuitry 143 and/or memory 102 may also be operably coupled to one or more other software and/or hardware components, including, but not limited to, one or more of the components illustrated in FIG. 1.

Processing circuitry 143 may execute machine learning system 104 and image classification model 120 using virtualization modules, such as a virtual machine or container executing on underlying hardware. One or more of such modules may execute as one or more services of an operating system or computing platform. Aspects of machine learning system 104 and image classification model 120 may execute as one or more executable programs at an application layer of a computing platform.

One or more input devices 144 of computing system 100 may generate, receive, or process input. Such input may include input from a keyboard, pointing device, voice responsive system, video camera, biometric detection/response system, button, sensor, mobile device, control pad, microphone, presence-sensitive screen, network, or any other type of device for detecting input from a human or machine.

One or more output devices 146 may generate, transmit, or process output. Examples of output are visual, video, tactile, and/or audio output. Output devices 146 may include a display, sound card, video graphics adapter card, speaker, presence-sensitive screen, one or more USB interfaces, video and/or audio output interfaces, or any other type of device capable of generating tactile, audio, video, or other output. Output devices 146 may include a display device, which may function as an output device using technologies including liquid crystal displays (LCD), quantum dot display, dot matrix displays, light emitting diode (LED) displays, organic light-emitting diode (OLED) displays, cathode ray tube (CRT) displays, e-ink, or monochrome, color, or any other type of display capable of generating tactile, audio, and/or visual output. In some examples, computing system 100 may include a presence-sensitive display that may serve as a user interface device that operates both as one or more input devices 144 and one or more output devices 146.

One or more communication units 145 of computing system 100 may communicate with devices external to computing system 100 (or among separate computing devices of computing system 100) by transmitting and/or receiving data, and may operate, in some respects, as both an input device and an output device. In some examples, communication units 145 may communicate with other devices over a network. In other examples, communication units 145 may send and/or receive radio signals on a radio network such as a cellular radio network. Examples of communication units 145 include a network interface card (e.g., such as an Ethernet card), an optical transceiver, a radio frequency transceiver, a GPS receiver, or any other type of device that can send and/or receive information. Other examples of communication units 145 may include Bluetooth®, GPS, 3G, 4G, and Wi-Fi® radios found in mobile devices as well as Universal Serial Bus (USB) controllers and the like.

In accordance with aspects of this disclosure, processing circuitry 143 may perform content-based compression of images to reduce the amount of storage space that may be required to store images that are used to train machine learning model 106.

Processing circuitry 143 of computing system 100 may segment an image frame into a plurality of probabilistic regions each associated with a corresponding confidence level of being within a region of interest (RoI) in the image frame out of a plurality of confidence levels of being within the region of interest. That is, processing circuitry 143 may determine a plurality of probabilistic regions in an image frame, where each probabilistic region is a region in the image frame having a different confidence level of containing a portion of a region of interest in the region.

A region of interest within an image frame may be an area or region (e.g., of pixels or blocks) of the image that contains an object of interest. In the context of vehicle operation and navigation, an object of interest in an image frame may be a vehicle, an obstacle, a pedestrian, a cyclist, a road sign, a lane boundary, a road boundary, and the like.

To perform probabilistic classification of an image frame, processing circuitry 143 may segment the image frame into a plurality of probabilistic regions based on the corresponding probability of each pixel or block of the image frame being within a region of interest in the image frame. In some examples, the corresponding probability of a block or pixel being within a region of interest may be a value that ranges from 0.0 to 1.0. Processing circuitry 143 may determine, for each pixel or block of the image frame, a corresponding probability of the pixel or block being within a region of interest in the image frame. Processing circuitry 143 may therefore determine, for each pixel or block of the image frame, a probabilistic region that includes or encompasses the pixel or block based on the corresponding probability of the pixel or block being within a region of interest in the image frame.

In contrast to binary classification in which an image frame is segmented into two regions: a RoI region and a non-RoI region, processing circuitry 143 may segment an image frame into three or more probabilistic regions. Processing circuitry 143 may determine a first probabilistic region having the highest confidence level of being within a region of interest, a second probabilistic region having a second highest confidence level of being within a region of interest, a third probabilistic region having a third highest confidence level of being within a region of interest, and so on.

For example, processing circuitry 143 may determine that the first probabilistic region encompasses pixels or blocks of the image frame each having a corresponding probability of being within a region of interest that is greater than or equal to a RoI threshold value, which may be a value between 0.0 and 1.0, such as 0.8 or 0.9. Similarly, processing circuitry 143 may determine that the second probabilistic region encompasses pixels or blocks of the image frame each having a corresponding probability of being within a region of interest that is less than the RoI threshold value but is greater than a second RoI threshold value, such as 0.5. Processing circuitry 143 may also determine that the third probabilistic region encompasses pixels or blocks of the image frame each having a corresponding probability of being within a region of interest that is less than the second RoI threshold value.

In some examples, processing circuitry 143 may segment an image frame into a plurality of probabilistic regions that include a certain RoI region, a probable RoI region, a probable non-RoI region, and a certain non-RoI region. Throughout this disclosure, the certain RoI region is also referred to as the certain area of interest region, the probable RoI region is also referred to as the probable area of interest region, the probable non-RoI region is also referred to as the probable non-area of interest region, and the certain non-RoI region is also referred to as the certain non-area of interest region.

The certain RoI region may be associated with the highest confidence level of being within a RoI out of the probabilistic regions. For example, processing circuitry 143 may determine, in the image frame, a certain RoI region that is made up of blocks or pixels each having a corresponding probability of being within a RoI that is greater than or equal to a RoI threshold value, such as 0.8 or 0.9.

The probable RoI region may be associated with the second highest confidence level of being within a RoI out of the probabilistic regions. For example, processing circuitry 143 may determine, in the image frame, a probable RoI region that is made up of blocks or pixels each having a corresponding probability of being within a RoI that is less than the RoI threshold value but is greater than 0.0. Including such pixels or blocks in the probable RoI region may capture pixels or blocks having a distribution of probabilities that include probabilities of around 0.5 for multiple classes, rather than having a high probability for a single class, which may indicate that those pixels or blocks are near the boundaries of an object of interest. In this way, the probable RoI region may be a region that includes pixels or blocks surrounding the edges and/or boundaries of the certain RoI region, and may help to preserve details of the image frame around object boundaries after compression of the image frame.

The probable non-RoI region may be associated with the third highest confidence level of being within a RoI out of the probabilistic regions. The probable non-RoI region may include pixels or blocks that are most likely to contain background or non-objects, but may include pixels of an object of interest. For example, processing circuitry 143 may determine the probable non-RoI region to encompass pixels or blocks of the image frame that are located within a threshold distance (e.g., a specific number of pixels) outwards from the outer boundary of the probable RoI region. The probable non-RoI region may, by surrounding the probable RoI region, be a region that includes pixels or blocks at or around object boundaries, and may therefore help to preserve details of the image frame around such object boundaries after compression of the image frame.

The certain non-RoI region may be associated with the fourth highest confidence level of being within a RoI out of the probabilistic regions and may include any pixels or blocks that are not included in the certain RoI region, the probable RoI region, and the probable non-RoI region. The pixels or blocks of the certain non-RoI region may therefore be pixels or blocks that are predicted with high confidence of being background and/or as not containing pixels of an object of interest.

Computing system 100 may include image classification model 120 that computing system 100 may use to determine, for each pixel or block of an image frame, a corresponding probability of the pixel or block being within a region of interest in the image frame. Image classification model 120 may be a neural network model trained via machine learning to perform semantic segmentation of image frames. Semantic segmentation is a technique for classifying each pixel or block of an image into one of a plurality of predefined classes. By classifying each pixel or block of an image into one of a plurality of predefined classes, semantic segmentation may mark the specific boundaries and shapes of different objects and regions in the image. For example, semantic segmentation mark, within an image, the boundaries and shapes of a traversable road, a building, a road sign, an automobile, a cyclist, a pedestrian, and the like.

Processing circuitry 143 may execute image classification model 120 to perform semantic segmentation of an image frame to output, for each pixel of the image frame, a corresponding distribution of probabilities of the pixel being a corresponding plurality of classes. The corresponding distribution of probabilities for a pixel of an image frame may be a plurality of classes, such as five classes, each having an associated probability, where the sum of the associated probabilities of the plurality of classes add up to 1.0.

The plurality of classes may include objects such as a vehicle, an obstacle, a pedestrian, a cyclist, a lane boundary, a road boundary, a road surface, the sky, a building, background, and the like. The plurality of classes may also include a background class, which may indicate that the pixel or block does not belong to an object. One or more of the objects in the plurality of classes may be an object of interest. In the context of vehicle operation and navigation, an object of interest may include a vehicle, an obstacle, a pedestrian, a cyclist, a lane boundary, a road boundary, and the like, but may not include road surfaces, the sky, buildings, a background, and the like.

Processing circuitry 143 may determine, for each pixel of an image frame, a corresponding probability of being in the region of interest based on the corresponding distribution of probabilities for the pixel. In some examples, processing circuitry 143 may determine, for a pixel, the corresponding probability of the pixel being within a region of interest in the image frame to be the probability associated with an object of interest having the highest probability out of the corresponding distribution of probabilities for the pixel across the classes.

For example, assume that image classification model 120 outputs, for a pixel, a distribution of probabilities of 0.6 vehicle, 0.3 lane boundary, and 0.1 road surface. In this example, the corresponding probability of the pixel being within a region of interest in the image frame may be 0.6, which is the probability of the pixel being a vehicle, which is the object of interest having a highest probability out of the distribution of probabilities for the pixel across the classes.

In another example, if image classification model 120 outputs, for a pixel, a distribution of probabilities of 0.5 road surface, 0.3 lane boundary, and 0.2 road boundary, processing circuitry 143 may determine the corresponding probability of the pixel being within a region of interest in the image frame to be 0.3, which is the probability of the pixel being a lane boundary, which is the object of interest having a highest probability out of the distribution of probabilities for the pixel across the classes. In this example, even though a road surface has the highest probability of 0.5 out of the distribution of probabilities for the pixel, the corresponding probability of the pixel being within a region of interest in the image frame is not 0.5 because the road surface is not an object of interest.

In some examples, if image classification model 120 outputs, for a pixel, a distribution of probabilities in which the highest probability is associated with a class that is not an object of interest, processing circuitry 143 may determine the corresponding probability of the pixel being within a region of interest in the image frame to be 0.0. For example, if image classification model 120 outputs, for a pixel, a distribution of probabilities of 0.5 road surface, 0.3 lane boundary, and 0.2 road boundary, processing circuitry 143 may determine the corresponding probability of the pixel being within a region of interest in the image frame to be 0.0, because the highest probability is associated with a road surface, which is not an object of interest.

In some examples, processing circuitry 143 may determine, for each block of an image frame, a corresponding probability of being in the region of interest based on the corresponding distribution of probabilities for the pixel or block. An image frame may include a plurality of blocks, where a block of the image frame may be a contiguous set of pixels in the image frame, such as a 4×4 block of pixels, a 8×8 block pixels, a 16×16 block of pixels, and the like.

To determine the corresponding probability of a block being within a region of interest in an image frame, processing circuitry 143 may execute image classification model 120 to perform semantic segmentation of the image frame to determine, for each pixel of the block, a corresponding distribution of probabilities of the pixel being a corresponding plurality of classes. Processing circuitry 143 may accumulate the probabilities of each of the plurality of classes across all of the pixels of the block to determine, for each of the corresponding plurality of classes, an accumulated probability of the class. Processing circuitry 143 may divide the accumulated probabilities of each class by the number of pixels in the block to determine, for each of the corresponding plurality of classes, an average probability (e.g., mean probability) or weighted average probability of the class across the pixels of the block. In other examples, the average probability may be the median or mode of the probability of the class across the pixels of the block. In this way, processing circuitry 143 may determine a corresponding distribution of average probabilities for a block of image data.

An example equation for determining the probability τ of a block having M pixels being within a region of interest is illustrated below:

$$τ = \frac{1}{M} {\sum }_{m = 1}^{M} {\sum }_{c}^{C} ( {y}_{m} = c ) conf ( {y}_{m} )$$

According to this equation, processing circuitry 143 may determine, for each pixel m of a block and for each class c of a plurality of classes C, a conf (yₘ), which is the probability of a pixel m being a class c. One or more classes may sum the probabilities of each class c of classes C across M pixels, and may divide each of the probabilities by M to determine, for each class c of a plurality of classes C, an average probability of the block being class c.

Processing circuitry 143 may determine, for each block of an image frame, a corresponding probability of being in the region of interest based on the corresponding distribution of average probabilities for the block. In some examples, processing circuitry 143 may determine, for a block, the corresponding probability of the block being within a region of interest in the image frame to be the average probability associated with an object of interest having the highest average probability out of the corresponding distribution of average probabilities for the block.

For example, if processing circuitry 143 determines, for a block, a distribution of average probabilities of 0.6 vehicle, 0.3 lane boundary, and 0.1 road surface, the corresponding probability of the block being within a region of interest in the image frame may be 0.6, which is the average probability of the block being a vehicle, which is the object of interest having a highest average probability out of the distribution of average probabilities for the block.

In another example, if processing circuitry 143 determines, for a block, a distribution of probabilities of 0.5 road surface, 0.3 lane boundary, and 0.2 road boundary, processing circuitry 143 may determine the corresponding probability of the block being within a region of interest in the image frame to be 0.3, which is the average probability of the block being a lane boundary, which is the object of interest having a highest average probability out of the distribution of average probabilities for the block. In this example, even though a road surface has the highest average probability of 0.5 out of the distribution of average probabilities for the block, the corresponding probability of the block being within a region of interest in the image frame is not 0.5 because the road surface is not an object of interest.

In some examples, if processing circuitry 143 determines, for a block, a distribution of average probabilities in which the highest average probability is associated with a class that is not an object of interest, processing circuitry 143 may determine the corresponding probability of the block being within a region of interest in the image frame to be 0.0. For example, if processing circuitry 143 determines, for a block, a distribution of average probabilities of 0.5 road surface, 0.3 lane boundary, and 0.2 road boundary, processing circuitry 143 may determine the corresponding probability of the block being within a region of interest in the image frame to be 0.0, because the highest average probability is associated with a road surface, which is not

Processing circuitry 143 may determine, for each of the plurality of probabilistic regions, a corresponding compression ratio of a plurality of compression ratios based on the corresponding confidence level of being within the region of interest. For example, processing circuitry 143 may determine, for each of the plurality of probabilistic regions, a corresponding compression ratio of a plurality of compression ratios that inversely correlates with the corresponding confidence level of being within the region of interest. That is, a first probabilistic region having a relatively greater confidence level of being within the region of interest than a second probabilistic region may have a corresponding compression ratio that is lower than the corresponding compression ratio for the second probabilistic region.

In some examples, a compression ratio for a probabilistic region may correspond to one or more compression parameters, such as one or more quantization parameters. For example, processing circuitry 143 may determine a corresponding compression ratio for a probabilistic region by determining one or more quantization parameter values for compressing the region, where a higher quantization parameter value for a probabilistic region may indicate a higher amount of compression for the probabilistic region

In some examples, such as collection of training data for training perception models, higher quality may be desired in RoI regions, and the probability (e.g., confidence level) of being within the RoI may be inversely correlated with quantization parameters. That is, processing circuitry 143 may determine, for each of the plurality of probabilistic regions, a corresponding compression ratio of a plurality of compression ratios that inversely correlates with the corresponding confidence level of being within the region of interest.

In some examples, such as logging for forensic purposes, higher quality is desired in non-RoI regions to facilitate analysis of RoI detection failures. In these examples, the probability (e.g., confidence level) of being within the RoI may be directly correlated with quantization parameters. That is, processing circuitry 143 may determine, for each of the plurality of probabilistic regions, a corresponding compression ratio of a plurality of compression ratios that correlates with the corresponding confidence level of being within the region of interest.

In examples where the plurality of probabilistic regions includes a certain RoI region, a probable RoI region, a probable non-RoI region, and a certain RoI region, the certain RoI region may be associated with the highest corresponding confidence level of being within the region of interest out of the plurality of probabilistic regions. The probable RoI region maybe associated with a second highest corresponding confidence level of being within the region of interest out of the plurality of probabilistic regions. The probable non-RoI region maybe associated with a third highest corresponding confidence level of being within the region of interest out of the plurality of probabilistic regions. The certain RoI region maybe associated with a fourth highest corresponding confidence level of being within the region of interest out of the plurality of probabilistic regions.

Processing circuitry 143 may therefore, in examples where the confidence level of being within the region of interest inversely correlates with the compression ratio, determine a corresponding compression ratio for the certain RoI region that is lower than the corresponding compression ratios for the probable RoI region, the probable non-RoI region, and the certain RoI region. As such, the certain RoI region may be the least compressed probabilistic region out of the plurality of probabilistic regions, including no compression.

Similarly, processing circuitry 143 may, in examples where the confidence level of being within the region of interest inversely correlates with the compression ratio, determine a corresponding compression ratio for the probable RoI region that is greater than the corresponding compression ratio for the certain RoI region and is less than the corresponding compression ratios for the probable non-RoI region and the certain RoI region. As such, the probable RoI region may be the second lowest compressed probabilistic region out of the plurality of probabilistic regions.

Processing circuitry 143 may, in examples where the confidence level of being within the region of interest inversely correlates with the compression ratio, also determine a corresponding compression ratio for the probable non-RoI region that is greater than the corresponding compression ratios for the certain RoI region and the probable RoI region, and is less than the corresponding compression ratio for the certain RoI region. As such, the probable non-RoI region may be the third lowest compressed probabilistic region out of the plurality of probabilistic regions.

Processing circuitry 143 may, in examples where the confidence level of being within the region of interest inversely correlates with the compression ratio, also determine a corresponding compression ratio for the certain non-RoI region that is greater than the corresponding compression ratios for the certain RoI region, the probable RoI region, and the probable RoI region. In this way, the certain non-RoI region may be the most heavily compressed probabilistic region out of the plurality of probabilistic regions.

Processing circuitry 143 may gradually change the compression ratios of pixels or blocks across boundaries of adjacent probabilistic regions of an image frame to reduce abrupt changes in compression ratios between boundaries of adjacent probabilistic regions. Reducing abrupt changes in compression ratios between boundaries of adjacent probabilistic regions may reduce compression artifacts at or near such boundaries.

As discussed above, quantization parameter (QP) values may control the amount of quantization applied to pixels of an image frame, and may correspond to the amount of compression that is applied to the pixels of the image frame. To gradually change the compression ratios of pixels or blocks across boundaries of adjacent probabilistic regions of an image frame, processing circuitry 143 may gradually change QP values for compressing the image frame across boundaries of probabilistic regions. In this way, processing circuitry 143 may perform spatial smoothing of QP values across boundaries of adjacent probabilistic regions to gradually change the compression ratios of pixels or blocks the boundaries.

For example, a first probabilistic region is compressed according to a first QP value, and an adjacent second probabilistic region is compressed according to a second QP value that is greater than the first QP value. Instead of abruptly changing QP values at the boundary between the first and second probabilistic regions, processing circuitry 143 may perform spatial smoothing of QP values across the boundary between the first and second probabilistic regions by gradually increasing the QP values for pixels or blocks of the image frame, starting with pixels or blocks within the first probabilistic region at or near the boundary and across to pixels or blocks within the second probabilistic region at or near the boundary, until the QP value reaches the second QP value in the second probabilistic region.

In this example, if the first probabilistic region is compressed according to a first QP value of 5, and if the second probabilistic region is compressed according to a second QP value of 10, processing circuitry 143 may, starting at pixels in the first probability region that are near the boundary between the first and second probabilistic regions, gradually increase the QP value from 5 to 10 across the boundary between the first and second probabilistic regions. For example, processing circuitry 143 may set the QP value of pixels in the first probabilistic region that are one pixel away from the boundary between the first and second probabilistic regions to 6, set the QP value of pixels in the first probabilistic region that are at the boundary to 7, set the QP value of pixels in the second probabilistic region that are at the boundary to 8, and set the QP value of pixels in the second probabilistic region that are one pixel away from the boundary to 9, thereby gradually increasing the QP values across the boundary between the first and second probabilistic regions from 5 to 10.

In some examples, processing circuitry 143 may perform spatial smoothing of QP values across boundaries of probabilistic regions of an image frame using sliding windows of average QP values. For example, processing circuitry 143 may calculate, for a sliding window, such as a 4×4 sliding window, which is a sliding window containing a 4×4 block of pixels, the average QP value of the pixels within the sliding window.

Processing circuitry 143 may adjust (e.g., increase or decrease) the QP values for pixels at or near the boundaries of probabilistic regions such that the average QP values of sliding windows at or near the boundaries between probabilistic regions differ by no more than a specified QP value threshold from the average QP values of adjacent sliding windows. For example, processing circuitry 143 may gradually increase the QP values of pixels across a boundary between a first probabilistic region associated with a first QP value and a second probabilistic region associated with a second QP value, starting from within the first probabilistic region and ending within the probabilistic region, to gradually increase the QP values of the pixels from the first QP value to the second QP value. Processing circuitry 143 may gradually increase the QP values of the pixels such that the average QP values of sliding windows at or near the boundaries between probabilistic regions differ by no more than a specified QP value threshold, such as 1 or 2, from the average QP values of adjacent sliding windows. In this way, processing circuitry 143 may be able to spatial smooth QP values across the boundary between probabilistic regions.

Processing circuitry 143 may compress each of the plurality of probabilistic regions according to the corresponding compression ratio to compress the image frame. For example, as discussed above, each pixel in the image frame may be associated with a corresponding QP value, and processing circuitry 143 may compress the image frame according to the corresponding QP values of the pixels in the image frame.

Processing circuitry 143 may therefore store the compressed image frame in a storage device of computing system 100, such as in memory 102, and/or may send the compressed image frame to another computing system or another storage system for storage.

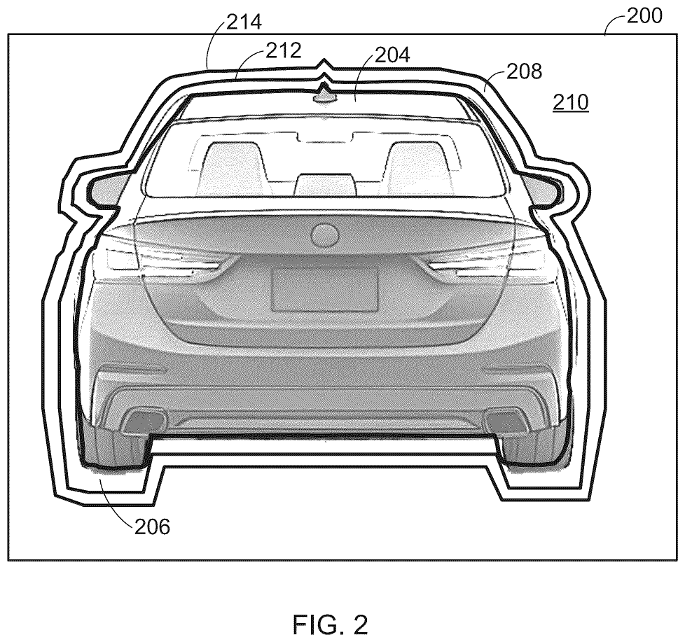

FIG. 2 is a conceptual diagram illustrating probabilistic segmentation of an example image frame, according to the techniques of this disclosure. FIG. 2 is described with respect to computing system 100 of FIG. 1.

As shown in FIG. 2, image frame 200 may an image, such as a frame of a video, that may be used to train an automotive perception model to detect objects. In the example of FIG. 2, image frame 200 may include an object of interest in the form of a vehicle.

Processing circuitry 143 may execute image classification model 120 to determine, for each pixel or block of image frame 200, a corresponding probability of the pixel or block being within a region of interest in image frame 200. Processing circuitry 143 may execute image classification model 120 to output, for each pixel of image frame 200, a distribution of probabilities of the pixel being a corresponding plurality of objects. As described above with respect to FIG. 1, processing circuitry 143 may determine, for each pixel or block of image frame 200, a corresponding probability of the pixel or block being within a region of interest based on the corresponding distributions of probabilities of each of the pixels of image frame 200 being a corresponding plurality of objects.

Processing circuitry 143 may segment image frame 200 into a plurality of probabilistic regions based on the corresponding probabilities of the pixels or blocks of image frame 200 being within a region of interest in image frame 200. In the example of FIG. 2, processing circuitry 143 may segment image frame 200 into a plurality of probabilistic regions of image frame 200 that include certain region of interest region 204 (“certain RoI region 204”), probable region of interest region 206 (“probable RoI region 206”), probable non-region of interest region 208 (“probable non-RoI region 208”), and certain non-region of interest region 210 (“certain non-RoI region 210”).

Certain RoI region 204 may be associated with the highest confidence level of being within a region of interest in the image frame 200 out of the plurality of probabilistic regions. Processing circuitry 143 may determine certain RoI region 204 to encompass pixels or blocks of image frame 200 each having a corresponding probability of being within a region of interest that is higher than a RoI threshold value. Such a RoI threshold value may be a value between 0.0 and 1.0, such as 0.8 or 0.9. In the example where the RoI threshold value is 0.8, processing circuitry 143 may include, in certain RoI region 204, pixels or blocks of image frame 200 each having a corresponding probability of being in the region of interest that is greater than the RoI threshold value of 0.8, and may not include, in the certain RoI region 204, pixels or blocks of image frame 200, pixels or blocks having a corresponding probability of being in the region of interest that is less than the RoI threshold value.

In some examples, processing circuitry 143 may determine certain RoI region 204 to encompass pixels or blocks of image frame 200 each having a corresponding probability of being within a region of interest that is greater than or equal to the RoI threshold value. In the example where the RoI threshold value is 0.9, processing circuitry 143 may include, in the certain RoI region 204, pixels or blocks of image frame 200 each having a corresponding probability of being in the region of interest that is at least the RoI threshold value of 0.9, and may not include, in the certain RoI region 204, pixels or blocks of image frame 200, pixels or blocks having a corresponding probability of being in the region of interest that is less than the RoI threshold value.

Probable RoI region 206 may be associated with the second highest confidence level of being within a region of interest in the image frame 200 out of the plurality of probabilistic regions. Processing circuitry 143 may determine probable RoI region 206 to encompass pixels or blocks of image frame 200 each having a corresponding probability of being within a region of interest that is lower than a RoI threshold value. That is, processing circuitry 143 may include, in probable RoI region 206, pixels or blocks of image frame 200 each having a corresponding non-zero probability of being in the region of interest that is less than a RoI threshold value. In the example where the RoI threshold value is 0.8, processing circuitry 143 may include, in the probable RoI region 206, pixels or blocks of image frame 200 each having a corresponding probability of being in the region of interest that is greater than 0.0 and less than the RoI threshold value of 0.8.

In some examples, to determine the pixels or blocks that is encompassed within probable RoI region 206, processing circuitry 143 may determine, for each pixel or block of image frame 200, a corresponding uncertainty value. The corresponding uncertainty value for a pixel or a block may be 1.0 minus the corresponding probability of the pixel or block being within a region of interest in image frame 200. Correspondingly, processing circuitry 143 may determine an uncertainty threshold value. For example, the uncertainty threshold value may be the difference between 1.0 and the RoI threshold value (i.e., 1.0 minus the RoI threshold value). Thus, if the RoI threshold value is 0.9, the uncertainty threshold value would be 0.1.

Processing circuitry 143 may determine that probable RoI region 206 encompasses pixels or blocks of image frame 200 each having a corresponding uncertainty of being in the region of interest that is greater than an uncertainty threshold value and is less than 1.0. In the example where the uncertainty threshold value is 0.1, processing circuitry 143 may determine probable RoI region 206 that encompasses pixels or blocks of image frame 200 each having a corresponding uncertainty value that is greater than 0.1 and less than 1.0.

Probable non-RoI region 208 may be associated with the third highest confidence level of being within a region of interest in the image frame 200 out of the plurality of probabilistic regions. Processing circuitry 143 may determine probable non-RoI region 208 to encompass pixels or blocks of image frame 200 that are located within a threshold distance (e.g., a specific number of pixels) outwards from the outer boundary 212 of probable region of interest region 206. For example, processing circuitry 143 may determine probable non-RoI region 208 to encompass pixels or blocks of image frame 200 that are located within five pixels outwards from the outer boundary 212 of probable RoI region 206.

Certain non-RoI region 210 may be associated with the lowest (e.g., fourth highest) confidence level of being within a region of interest in the image frame 200 out of the plurality of probabilistic regions. Processing circuitry 143 may determine certain non-RoI region 210 to encompass remaining pixels or blocks of image frame 200 that are not encompassed by a certain region of interest region such as certain RoI region 204, a probable region of interest region, such as probable RoI region 206, or a probable non-region of interest region, such as probable non-RoI region 208, such as any pixels or block that are outside of the outer boundary 214 of probable non-RoI region 208.

In the example where the plurality of probabilistic regions includes a certain region of interest such as certain RoI region 204, a probable region of interest such as probable RoI region 206, a probable non-region of interest such as probable non-RoI region 208, and a certain non-region of interest such as interest region 210, the certain region of interest may have a corresponding compression ratio that is smaller than the corresponding compression ratio of the probable region of interest. The probable region of interest may have a corresponding compression ratio that is smaller than the corresponding compression ratio of the probable non-region of interest. The probable non-region of interest may have a corresponding compression ratio that is smaller than the corresponding compression ratio of the certain non-region of interest.

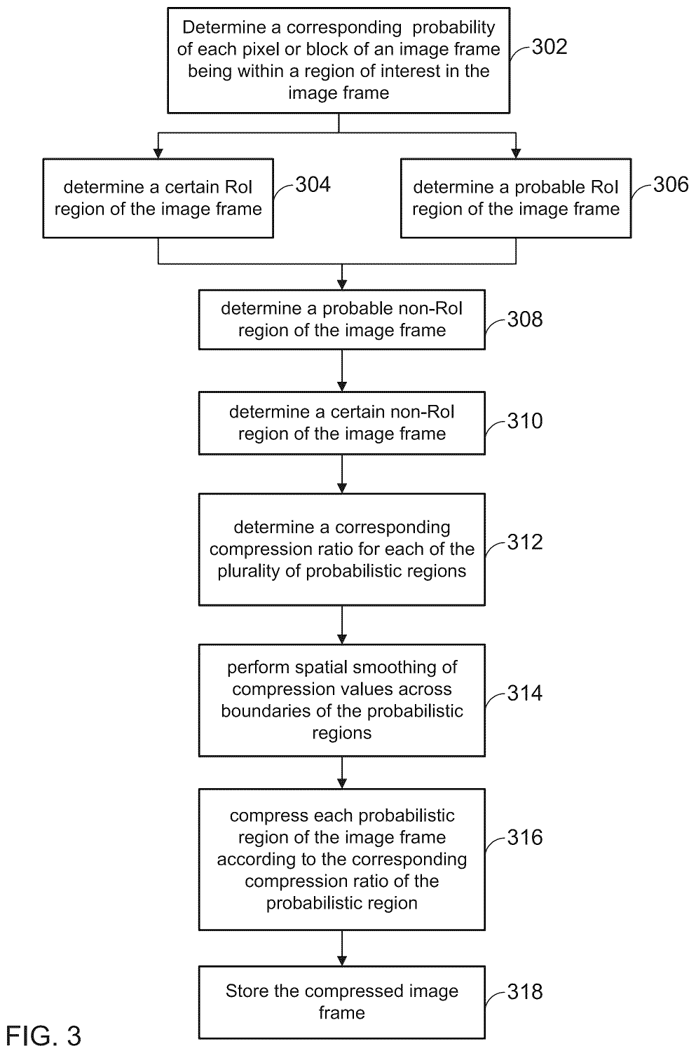

FIG. 3 is a flowchart showing an example method for performing content-based image compression of an image frame, according to the techniques of this disclosure. For ease, the example is described with respect to FIG. 1.

As shown in FIG. 3, processing circuitry 143 may determine, for each pixel or block of an image frame, a corresponding probability of the pixel or block being within a region of interest in the image frame (302). Processing circuitry 143 may execute image classification model 120 to output, for each pixel or block of image frame 200, a distribution of probabilities of the pixel or block being a corresponding plurality of objects.

Processing circuitry 143 may determine a certain RoI region of the image frame (304). Processing circuitry 143 may determine the certain RoI region to encompass pixels or blocks having a probability of being within a RoI that is greater than or equal to a RoI threshold value.

Processing circuitry 143 may determine a probable RoI region of the image frame (306). Processing circuitry 143 may determine the probable RoI region to encompass pixels or blocks having a probability of being within a RoI that is greater than 0.0 and is less than the RoI threshold value.

Processing circuitry 143 may determine a probable non-RoI region of the image frame (308). Processing circuitry 143 may determine the probable non-RoI region to encompass pixels or blocks that are located within a threshold distance outwards from the outer boundary of the probable RoI region.

Processing circuitry 143 may determine a certain non-RoI region of the image frame (310). Processing circuitry 143 may determine the certain non-RoI region to encompass any pixels or blocks that are not within any of the certain RoI region, the probable RoI region, or the probable non-RoI region. Such a certain non-RoI region may be a region of the image frame that is certain to not contain any part of an object of interest.

Processing circuitry 143 may determine a corresponding compression ratio for each of the plurality of probabilistic regions (312). A corresponding compression ratio for a region is a measure of how heavily processing circuitry 143 may compress the region. Processing circuitry 143 may determine, for the certain RoI region of the image frame, a corresponding compression ratio that is the lowest compression ratio out of the plurality of probabilistic regions. That is, processing circuitry 143 may not reduce the size of the certain RoI region via compression as heavily as the other probabilistic regions of the image frame.

Processing circuitry 143 may determine, for the probable RoI region of the

image frame, a corresponding compression ratio that is the second lowest compression ratio out of the plurality of probabilistic regions. That is, processing circuitry 143 may more heavily compress the probable RoI region compared to the certain RoI region, but may not as heavily compress the probable RoI region compared to the probable non-RoI region and the certain non-RoI region.

Processing circuitry 143 may determine, for the probable non-RoI region of the image frame, a corresponding compression ratio that is the third lowest compression ratio out of the plurality of probabilistic regions. That is, processing circuitry 143 may more heavily compress the probable non-RoI region compared to the certain RoI region and the probable RoI region, but may not as heavily compress the probable non-RoI region compared to the certain non-RoI region.

Processing circuitry 143 may determine, for the certain non-RoI region of the image frame, a corresponding compression ratio that is the highest compression ratio out of the plurality of probabilistic regions. That is, processing circuitry 143 may more heavily compress the certain non-RoI region compared to the other probabilistic regions of the image frame.

Processing circuitry 143 may perform spatial smoothing of compression values across boundaries of the probabilistic regions of the image frame (314). That is, processing circuitry 143 may gradually increase or gradually decrease quantization parameter values across boundaries of the probabilistic regions to reduce block artifacts at such boundaries between probabilistic regions. For example, processing circuitry 143 may gradually increase quantization parameter values across the boundary of the certain RoI region and the probable RoI region, across the boundary of the probable RoI region and the probable non-RoI region, and across the boundary of the probable non-RoI region and the certain non-RoI region.

Processing circuitry 143 may compress each probabilistic region of the image frame according to the corresponding compression ratio of the probabilistic region (316). For example, processing circuitry 143 may compress each of the certain RoI region, the probable RoI region, the probable non-RoI region, and the certain non-RoI region of the image according to a different corresponding compression ratio.

Processing circuitry 143 may store the compressed image frame (318). Processing circuitry 143 may store the compressed image frame in memory 102 at computing system 100 or at an external computing device or computing system. A computing system, such as computing system 100, may decompress the image frame to reconstruct an image frame from the compressed image frame, and machine learning system 104 may train an automotive perception model, such as machine learning model 106, using a training dataset that includes the reconstructed image frame.

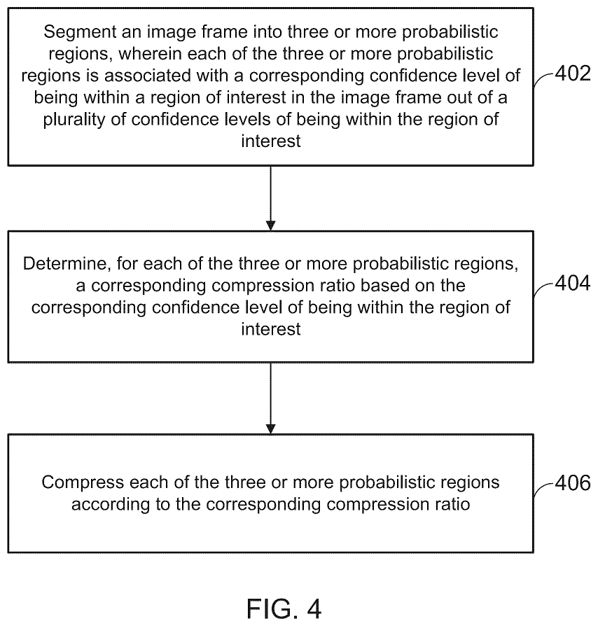

FIG. 4 is a flowchart showing an example method of operation according to the techniques of this disclosure. For ease, the example is described with respect to FIG. 1.

As shown in FIG. 4, processing circuitry 143 may segment an image frame into three or more probabilistic regions, wherein each of the three or more probabilistic regions is associated with a corresponding confidence level of being within a region of interest in the image frame out of a plurality of confidence levels of being within the region of interest (402). In some examples, to segment the image frame into the three or more probabilistic regions, processing circuitry 143 may determine, for a block of the image frame, a probability of the block being within the region of interest. Processing circuitry 143 may determine a probabilistic region that includes the block out of the three or more probabilistic regions based on the probability of the block being within the region of interest.

In some examples, to determine, for the block of the image frame, the probability of the block being within the region of interest, processing circuitry 143 may determine, using an image classification model 120, a corresponding distribution of probabilities of classes for each of a plurality of pixels of the block. Processing circuitry 143 may determine, based on the corresponding distribution of probabilities of classes for each of the plurality of pixels of the block, a distribution of average probabilities of classes for the block. Processing circuitry 143 may determine the probability of the block being within the region of interest as a probability of a most probable class associated with an object of interest out of the distribution of average probabilities of classes.

In some examples, to determine, for the block of the image frame, the probability of the block being within the region of interest, processing circuitry 143 may determine that the probability of the block being within the region of interest is greater than a specific threshold. Processing circuitry 143 may, in response to determining that the probability of the block being within the region of interest is greater than the specific threshold, include the block in a certain area of interest region associated with the highest confidence level of being within the region of interest out of the three or more probabilistic regions.

In some examples, to determine, for the block of the image frame, the

probability of the block being within the region of interest, processing circuitry 143 may determine that the probability of the block being within the region of interest is less than a second specific threshold. Processing circuitry 143 may, in response to determining that the probability of the block being within the region of interest is less than the second specific threshold, include the block in a probable area of interest region associated with a second highest confidence level of being within the region of interest out of the three or more probabilistic regions. In some examples, the probable area of interest region may surround a certain area of interest region associated with the highest confidence level of being within the region of interest.

In some examples, processing circuitry 143 may determine that a second block of the image frame is within a specified distance outwards from an outer boundary of the probable area of interest region. Processing circuitry 143 may, in response to determining that the second block is within the specified distance outwards from the outer boundary of the probable area of interest region, include the second block in a probable non-area of interest region associated with a third highest confidence level of being within the region of interest out of the three or more probabilistic regions.

In some examples, processing circuitry 143 may determine that a third block of the image frame is outside an outer boundary of the probable non-area of interest region. Processing circuitry 143 may, in response to determining that the third block is outside the outer boundary of the probable non-area of interest region, include the block in a certain non-area of interest region associated with a fourth highest confidence level of being within the region of interest out of the three or more probabilistic regions.

Processing circuitry 143 may determine, for each of the three or more probabilistic regions, a corresponding compression ratio of a plurality of compression ratios based on the corresponding confidence level of being within the region of interest (404). In some examples, to determine, for each of the three or more probabilistic regions, a corresponding compression ratio based on the corresponding confidence level of being within the region of interest, processing circuitry 143 may determine, for each of the three or more probabilistic regions, the corresponding compression ratio that inversely correlates with the corresponding confidence level of being within the region of interest.

For example, a certain area of interest region may have a corresponding compression ratio that is lower than the corresponding compression ratio for a probable area of interest region. A probable non-area of interest may have a corresponding compression ratio that is higher than the corresponding compression ratio for the probable area of interest. The certain non-area of interest may have a corresponding compression ratio that is higher than the corresponding compression ratios for the certain area of interest region, the probable area of interest region, and the probable non-area of interest region.

Processing circuitry 143 may compress each of the three or more probabilistic regions according to the corresponding compression ratio (406). In some examples, to compress each of the three or more probabilistic regions according to the corresponding compression ratio, processing circuitry 143 may spatially smooth quantization parameters across a boundary between a first probabilistic region and a second probabilistic region of the three or more probabilistic regions.

In some examples, compressing each of the three or more probabilistic regions includes compressing the image frame to generate a compressed image frame. Processing circuitry 143 may decompress the compressed image frame to generate a reconstructed image frame, and may train an automotive perception model using a training dataset that includes the reconstructed image frame.

The following describes other example aspects of the disclosure. The techniques of the following aspects may be used separately or in any combination.

Example 1. A method of image compression, the method comprising: segmenting an image frame into three or more probabilistic regions, wherein each of the three or more probabilistic regions is associated with a corresponding confidence level of being within a region of interest in the image frame out of a plurality of confidence levels of being within the region of interest; determining, for each of the three or more probabilistic regions, a corresponding compression ratio based on the corresponding confidence level of being within the region of interest; and compressing each of the three or more probabilistic regions according to the corresponding compression ratio.

Example 2. The method of example 1, wherein determining, for each of the three or more probabilistic regions, the corresponding compression ratio based on the corresponding confidence level of being within the region of interest comprises: determining, for each of the three or more probabilistic regions, the corresponding compression ratio that inversely correlates with the corresponding confidence level of being within the region of interest.

Example 3. The method of any of examples 1 and 2, wherein segmenting the image frame into the three or more probabilistic regions further comprises: determining, for a block of the image frame, a probability of the block being within the region of interest; and determining a probabilistic region that includes the block, out of the three or more probabilistic regions, based on the probability of the block being within the region of interest.

Example 4. The method of example 3, wherein determining, for the block of the image frame, the probability of the block being within the region of interest further comprises: determining, using an image classification model, a corresponding distribution of probabilities of classes for each of a plurality of pixels of the block; determining, based on the corresponding distribution of probabilities of classes for each of the plurality of pixels of the block, a distribution of average probabilities of classes for the block; and determining the probability of the block being within the region of interest as a probability of a most probable class associated with an object of interest out of the distribution of average probabilities of classes.

Example 5. The method of example 4, wherein determining the probabilistic region that includes the block, out of the three or more probabilistic regions, further comprises: determining that the probability of the block being within the region of interest is greater than a region of interest threshold; and in response to determining that the probability of the block being within the region of interest is greater than the region of interest threshold, including the block in a certain area of interest region associated with a highest confidence level of being within the region of interest out of the three or more probabilistic regions.

Example 6. The method of any of examples 4 and 5, wherein determining the probabilistic region that includes the block, out of the three or more probabilistic regions, further comprises: determining that the probability of the block being within the region of interest is less than a region of interest threshold; and in response to determining that the probability of the block being within the region of interest is less than the region of interest threshold, including the block in a probable area of interest region associated with a second highest confidence level of being within the region of interest out of the three or more probabilistic regions.

Example 7. The method of example 6, wherein the probable region of interest surrounds a certain area of interest region associated with a highest confidence level of being within the region of interest out of the three or more probabilistic regions.

Example 8. The method of any of examples 6 and 7, further comprising: determining that a second block of the image frame is within a specified distance outwards from an outer boundary of the probable area of interest region; and in response to determining that the second block is within the specified distance outwards from the outer boundary of the probable area of interest region, including the second block in a probable non-area of interest region associated with a third highest confidence level of being within the region of interest out of the three or more probabilistic regions.

Example 9. The method of example 8, further comprising: determining that a third block of the image frame is outside an outer boundary of the probable non-area of interest region; and in response to determining that the third block is outside the outer boundary of the probable non-area of interest region, including the third block in a certain non-area of interest region associated with a fourth highest confidence level of being within the region of interest out of the three or more probabilistic regions.

Example 10. The method of any of examples 1-9, wherein compressing each of the three or more probabilistic regions according to the corresponding compression ratio further comprises: spatially smoothing quantization parameter values across a boundary between a first probabilistic region and a second probabilistic region of the three or more probabilistic regions.

Example 11. The method of any of examples 1-10, wherein compressing each of the three or more probabilistic regions according to the corresponding compression ratio comprises compressing the image frame into a compressed image frame, the method further comprising: decompressing the compressed image frame to generate a reconstructed image frame; and training an automotive perception model using a training dataset that includes the reconstructed image frame.

Example 12. A computing system for image compression, the computing system comprising: one or more memories; and processing circuitry implemented in circuitry, coupled to the one or more memories, and configured to: segment an image frame into three or more probabilistic regions, wherein each of the three or more probabilistic regions is associated with a corresponding confidence level of being within a region of interest in the image frame out of a plurality of confidence levels of being within the region of interest; determine, for each of the three or more probabilistic regions, a corresponding compression ratio based on the corresponding confidence level of being within the region of interest; and compress each of the three or more probabilistic regions according to the corresponding compression ratio.

Example 13. The computing system of example 12, wherein to determine, for each of the three or more probabilistic regions, a corresponding compression ratio based on the corresponding confidence level of being within the region of interest, the processing circuitry is configured to: determine, for each of the three or more probabilistic regions, the corresponding compression ratio that inversely correlates with the corresponding confidence level of being within the region of interest.

Example 14. The computing system of any of examples 12 and 13, wherein to segment the image frame into the three or more probabilistic regions, the processing circuitry are further configured to: determine, for a block of the image frame, a probability of the block being within the region of interest; and determine a probabilistic region that includes the block out of the three or more probabilistic regions based on the probability of the block being within the region of interest.

Example 15. The computing system of example 14, wherein to determine, for the block of the image frame, the probability of the block being within the region of interest, the processing circuitry are further configured to: determine, using an image classification model, a corresponding distribution of probabilities of classes for each of a plurality of pixels of the block; determine, based on the corresponding distribution of probabilities of classes for each of the plurality of pixels of the block, a distribution of average probabilities of classes for the block; and determine the probability of the block being within the region of interest as a probability of a most probable class associated with an object of interest out of the distribution of average probabilities of classes.

Example 16. The computing system of example 15, wherein to determine the probabilistic region that includes the block, out of the three or more probabilistic regions, the processing circuitry are further configured to: determine that the probability of the block being within the region of interest is greater than a region of interest threshold; and in response to determining that the probability of the block being within the region of interest is greater than the region of interest threshold, include the block in a certain area of interest region associated with a highest confidence level of being within the region of interest out of the three or more probabilistic regions.

Example 17. The computing system of any of examples 15 and 16, wherein to determine the probabilistic region that includes the block, out of the three or more probabilistic regions, the processing circuitry are further configured to: determine that the probability of the block being within the region of interest is less than a region of interest threshold; and in response to determining that the probability of the block being within the region of interest is less than the region of interest threshold, include the block in a probable area of interest region associated with a second highest confidence level of being within the region of interest out of the three or more probabilistic regions.

Example 18. The computing system of example 17, wherein the probable area of interest surrounds a certain area of interest region associated with a highest confidence level of being within the region of interest out of the three or more probabilistic regions.

Example 19. The computing system of any of examples 17 and 18, wherein the processing circuitry are further configured to: determine that a second block of the image frame is within a specified distance outwards from an outer boundary of the probable area of interest region; and in response to determining that the second block is within the specified distance outwards from the outer boundary of the probable area of interest region, include the second block in a probable non-area of interest region associated with a third highest confidence level of being within the region of interest out of the three or more probabilistic regions.

Example 20. The computing system of example 19, wherein the processing circuitry are further configured to: determine that a third block of the image frame is outside an outer boundary of the probable non-area of interest region; and in response to determining that the third block is outside the outer boundary of the probable non-area of interest region, include the third block in a certain non-area of interest region associated with a fourth highest confidence level of being within the region of interest out of the three or more probabilistic regions.

Example 21. The computing system of any of examples 12-20, wherein to compress each of the three or more probabilistic regions according to the corresponding compression ratio, the processing circuitry are further configured to: spatially smooth quantization parameters across a boundary between a first probabilistic region and a second probabilistic region of the three or more probabilistic regions.

Example 22. A computer-readable storage medium storing instructions thereon that when executed cause processing circuitry to: segment an image frame into three or more probabilistic regions, wherein each of the three or more probabilistic regions is associated with a corresponding confidence level of being within a region of interest in the image frame out of a plurality of confidence levels of being within the region of interest; determine, for each of the three or more probabilistic regions, a corresponding compression ratio based on the corresponding confidence level of being within the region of interest; and compress each of the three or more probabilistic regions according to the corresponding compression ratio.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media. In this manner, computer-readable media generally may correspond to tangible computer-readable storage media which is non-transitory. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. It should be understood that computer-readable storage media and data storage media do not include carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of image compression, the method comprising:
segmenting an image frame into three or more probabilistic regions, wherein each of the three or more probabilistic regions is associated with a corresponding confidence level of being within a region of interest in the image frame out of a plurality of confidence levels of being within the region of interest;
determining, for each of the three or more probabilistic regions, a corresponding compression ratio based on the corresponding confidence level of being within the region of interest; and
compressing each of the three or more probabilistic regions according to the corresponding compression ratio.

2. The method of claim 1, wherein determining, for each of the three or more probabilistic regions, the corresponding compression ratio based on the corresponding confidence level of being within the region of interest comprises:
determining, for each of the three or more probabilistic regions, the corresponding compression ratio that inversely correlates with the corresponding confidence level of being within the region of interest.

3. The method of claim 1, wherein segmenting the image frame into the three or more probabilistic regions further comprises:
determining, for a block of the image frame, a probability of the block being within the region of interest; and
determining a probabilistic region that includes the block, out of the three or more probabilistic regions, based on the probability of the block being within the region of interest.

4. The method of claim 3, wherein determining, for the block of the image frame, the probability of the block being within the region of interest further comprises:
determining, using an image classification model, a corresponding distribution of probabilities of classes for each of a plurality of pixels of the block;
determining, based on the corresponding distribution of probabilities of classes for each of the plurality of pixels of the block, a distribution of average probabilities of classes for the block; and
determining the probability of the block being within the region of interest as a probability of a most probable class associated with an object of interest out of the distribution of average probabilities of classes.

5. The method of claim 4, wherein determining the probabilistic region that includes the block, out of the three or more probabilistic regions, further comprises:
determining that the probability of the block being within the region of interest is greater than a region of interest threshold; and
in response to determining that the probability of the block being within the region of interest is greater than the region of interest threshold, including the block in a certain area of interest region associated with a highest confidence level of being within the region of interest out of the three or more probabilistic regions.

6. The method of claim 4, wherein determining the probabilistic region that includes the block, out of the three or more probabilistic regions, further comprises:
determining that the probability of the block being within the region of interest is less than a region of interest threshold; and
in response to determining that the probability of the block being within the region of interest is less than the region of interest threshold, including the block in a probable area of interest region associated with a second highest confidence level of being within the region of interest out of the three or more probabilistic regions.

7. The method of claim 6, wherein the probable region of interest surrounds a certain area of interest region associated with a highest confidence level of being within the region of interest out of the three or more probabilistic regions.

8. The method of claim 6, further comprising:
determining that a second block of the image frame is within a specified distance outwards from an outer boundary of the probable area of interest region; and
in response to determining that the second block is within the specified distance outwards from the outer boundary of the probable area of interest region, including the second block in a probable non-area of interest region associated with a third highest confidence level of being within the region of interest out of the three or more probabilistic regions.

9. The method of claim 8, further comprising:
determining that a third block of the image frame is outside an outer boundary of the probable non-area of interest region; and
in response to determining that the third block is outside the outer boundary of the probable non-area of interest region, including the third block in a certain non-area of interest region associated with a fourth highest confidence level of being within the region of interest out of the three or more probabilistic regions.

10. The method of claim 1, wherein compressing each of the three or more probabilistic regions according to the corresponding compression ratio further comprises:
spatially smoothing quantization parameter values across a boundary between a first probabilistic region and a second probabilistic region of the three or more probabilistic regions.

11. The method of claim 1, wherein compressing each of the three or more probabilistic regions according to the corresponding compression ratio comprises compressing the image frame into a compressed image frame, the method further comprising:
decompressing the compressed image frame to generate a reconstructed image frame; and
training an automotive perception model using a training dataset that includes the reconstructed image frame.

12. A computing system for image compression, the computing system comprising:
one or more memories; and
processing circuitry implemented in circuitry, coupled to the one or more memories, and configured to:
segment an image frame into three or more probabilistic regions, wherein each of the three or more probabilistic regions is associated with a corresponding confidence level of being within a region of interest in the image frame out of a plurality of confidence levels of being within the region of interest;
determine, for each of the three or more probabilistic regions, a corresponding compression ratio based on the corresponding confidence level of being within the region of interest; and
compress each of the three or more probabilistic regions according to the corresponding compression ratio.

13. The computing system of claim 12, wherein to determine, for each of the three or more probabilistic regions, a corresponding compression ratio based on the corresponding confidence level of being within the region of interest, the processing circuitry is configured to:
determine, for each of the three or more probabilistic regions, the corresponding compression ratio that inversely correlates with the corresponding confidence level of being within the region of interest.

14. The computing system of claim 12, wherein to segment the image frame into the three or more probabilistic regions, the processing circuitry are further configured to:
determine, for a block of the image frame, a probability of the block being within the region of interest; and
determine a probabilistic region that includes the block out of the three or more probabilistic regions based on the probability of the block being within the region of interest.

15. The computing system of claim 14, wherein to determine, for the block of the image frame, the probability of the block being within the region of interest, the processing circuitry are further configured to:
determine, using an image classification model, a corresponding distribution of probabilities of classes for each of a plurality of pixels of the block;
determine, based on the corresponding distribution of probabilities of classes for each of the plurality of pixels of the block, a distribution of average probabilities of classes for the block; and
determine the probability of the block being within the region of interest as a probability of a most probable class associated with an object of interest out of the distribution of average probabilities of classes.

16. The computing system of claim 15, wherein to determine the probabilistic region that includes the block, out of the three or more probabilistic regions, the processing circuitry are further configured to:
determine that the probability of the block being within the region of interest is greater than a region of interest threshold; and
in response to determining that the probability of the block being within the region of interest is greater than the region of interest threshold, include the block in a certain area of interest region associated with a highest confidence level of being within the region of interest out of the three or more probabilistic regions.

17. The computing system of claim 15, wherein to determine the probabilistic region that includes the block, out of the three or more probabilistic regions, the processing circuitry are further configured to:
determine that the probability of the block being within the region of interest is less than a region of interest threshold; and
in response to determining that the probability of the block being within the region of interest is less than the region of interest threshold, include the block in a probable area of interest region associated with a second highest confidence level of being within the region of interest out of the three or more probabilistic regions.

18. The computing system of claim 17, wherein the probable area of interest surrounds a certain area of interest region associated with a highest confidence level of being within the region of interest out of the three or more probabilistic regions.

19. The computing system of claim 17, wherein the processing circuitry are further configured to:
determine that a second block of the image frame is within a specified distance outwards from an outer boundary of the probable area of interest region; and
in response to determining that the second block is within the specified distance outwards from the outer boundary of the probable area of interest region, include the second block in a probable non-area of interest region associated with a third highest confidence level of being within the region of interest out of the three or more probabilistic regions.

20. A computer-readable storage medium storing instructions thereon that when executed cause processing circuitry to:
segment an image frame into three or more probabilistic regions, wherein each of the three or more probabilistic regions is associated with a corresponding confidence level of being within a region of interest in the image frame out of a plurality of confidence levels of being within the region of interest;
determine, for each of the three or more probabilistic regions, a corresponding compression ratio based on the corresponding confidence level of being within the region of interest; and
compress each of the three or more probabilistic regions according to the corresponding compression ratio.
